(19) United States
(12) Patent Application Publication
(10) Pub. No.: US 2022/0212632 A1
(43) Pub. Date: Jul. 7, 2022

(54) WIND DEFLECTOR FOR A WINDSCREEN WIPER SYSTEM OF A MOTOR VEHICLE

(71) Applicants: AUDI AG, Ingolstadt (DE); DR. ING. H.C.F. PORSCHE AG, Stuttgart (DE); A.RAYMOND ET CIE, Grenoble (FR); VOLKSWAGEN AKTIENGESELLSCHAFT, Wolfsburg (DE)

(72) Inventors: Stephan Haefner, Prebitz (DE); Frank Ackermann, Koenigslutter am Elm (DE); Sven Auch, Stuttgart (DE); Axel Feger, Loerrach (DE); Karl Bode, Loerrach (DE)

(21) Appl. No.: 17/604,473

(22) PCT Filed: Apr. 14, 2020
(86) PCT No.: PCT/EP2020/060451

§ 371 Date: Oct. 18, 2021

(30) Foreign Application Priority Data
Apr. 16, 2019 (DE) 10 2019 110 084.4

(51) Int. Cl. B60S 1/04; B60S 1/52

(52) U.S. Cl. CPC B60S 1/0408; B60S 1/522

(57) ABSTRACT

A wind deflector for a windscreen wiper system of a motor vehicle has a receptacle for fastening the wind deflector on a component of a wiper arm of the windscreen wiper system. The wind deflector is at least partially formed from an elastic plastic component.

The invention relates to a wind deflector or the like functional element for a windscreen wiper system of a motor vehicle according to the preamble of claim 1.

From DE 87 16 154 U1, an add-on device for a windscreen wiper is already known, which has a wind deflecting function. The add-on device is manufactured from a plastic in an extrusion molding method and includes a receptacle for attaching a wiper rod of a wiper arm of the windscreen wiper system. In addition, the add-on device includes a receptacle for a hose of a windscreen washer system.

It is the object of the present invention to provide a wind deflector or the like functional element of the initially mentioned type, which can be particularly beneficially attached to the corresponding wiper arm of the windscreen wiper system.

According to the invention, this object is solved by a wind deflector or the like functional element having the features of claim 1. Advantageous configurations of the invention are the subject matter of the dependent claims.

The wind deflector according to the invention or the like functional element is first characterized in that it includes a receptacle for attaching to a component, in particular a wiper rod, of a wiper arm of the windscreen wiper system. In order to herein provide a wind deflector, which can be particularly beneficially attached to the component of the wiper arm in particular formed as a wiper rod on the one hand, and which for example has beneficial aerodynamic characteristics on the other hand and moreover does not cause damages or annoying noises upon contact with the windscreen to be wiped, according to the invention, the wind deflector or the like functional element is first at least partially formed of an elastic plastic component. Such a plastic component has the advantage that the receptacle or the receiving channel for arranging the wind deflector on the wiper rod can for example be formed in a length area of the elastic plastic component to thus for example encase the wiper rod in a bend area. Thus, the wind deflector can for example be shifted onto the wiper rod of the wiper arm in simple manner even if it does not have a rectilinear extension. In contrast, the receptacle can be formed of a hard plastic component at another location to obtain a particularly secure and fixed arrangement of the wind deflector on the wiper rod or another component of the wiper arm.

Furthermore, a partial configuration of the wind deflector of an elastic plastic component is advantageous to for example avoid damages or annoying knocking noises if the wind deflector for example strikes against the windscreen. For example, this can occur upon corresponding pressure surges, upon lift-off of the wiper blade and wiper arm, respectively, from the windscreen or in travels over an uneven roadway. Therein, damping is for example possible by the elastic plastic component such that the wind deflector impinging on the windscreen does not result in the described disadvantages. Thus, the wind deflector can also be arranged very close to the corresponding windscreen on the other hand, which results in aerodynamic advantages.

In further configuration of the invention, it has therein proven advantageous if the wind deflector is at least partially formed of a hard plastic component. Thus, those areas, for example the receptacle or the receiving channel for attaching the wind deflector to the wiper arm, can be specially provided of the hard plastic component to obtain a particularly reliable and stiff arrangement of the wind deflector on the wiper arm. Therein, the soft and elastic plastic component and the hard plastic component are for example employed within the scope of a two-component injection molding method or within the scope of a similar method to form the wind deflector to provide a wind deflector in simple manner, which has the previously described features and advantages.

Furthermore, it has proven advantageous if a windscreen cleaning device is integrated in the wind deflector. Hereby, a wind deflector with a corresponding dual function can be provided.

A further advantageous embodiment of the invention provides that a surface of the wind deflector related to its installation position is at least substantially formed by the elastic plastic component at least on a visible side. Thus, an optically advantageous, uniform and aerodynamic surface is provided on the one hand, which ensures, for example in case of corresponding collisions of the wind deflector and with the wind deflector, respectively, that such impacts or the like are softly absorbed on the other hand.

A further advantageous embodiment of the invention provides that at least substantially all of the liquid-carrying components of the windscreen cleaning device are formed of the hard plastic component. Thus, a windscreen cleaning device can be provided, which is tightly formed, and corresponding windscreen cleaning liquid is guided to the windscreen to be cleaned with high power.

In this context, it has further proven advantageous if the windscreen cleaning device is at least substantially completely integrated in the elastic plastic component. Thus, the windscreen cleaning device is particularly beneficially integrated in the elastic plastic component in hidden manner.

Furthermore, it has proven advantageous if the receptacle for attaching the wind deflector to a component of the wiper arm of the windscreen wiper system is preferably formed of the hard plastic component. Hereby, the particularly reliable, stable and stiff arrangement of the wind deflector on the corresponding wiper arm results.

A further advantageous embodiment of the invention provides that the receptacle is formed for attaching the wind deflector to a wiper rod of the wiper arm of the windscreen wiper system. Hereby, a particularly simple configuration of the entire windscreen wiper system results.

A further advantageous embodiment of the invention provides that an attachment device is provided for securing the wind deflector to the component of the wiper arm of the windscreen wiper system, which is formed of the hard plastic component. Thus, the wind deflector is also particularly beneficially and stably secured against movement along the wiper arm.

Finally, it has proven advantageous if the elastic plastic component is formed of a UV-resistant material to thus be preserved over the life cycle of the motor vehicle.

In the following, embodiments of the invention are described. Hereto, there shows:

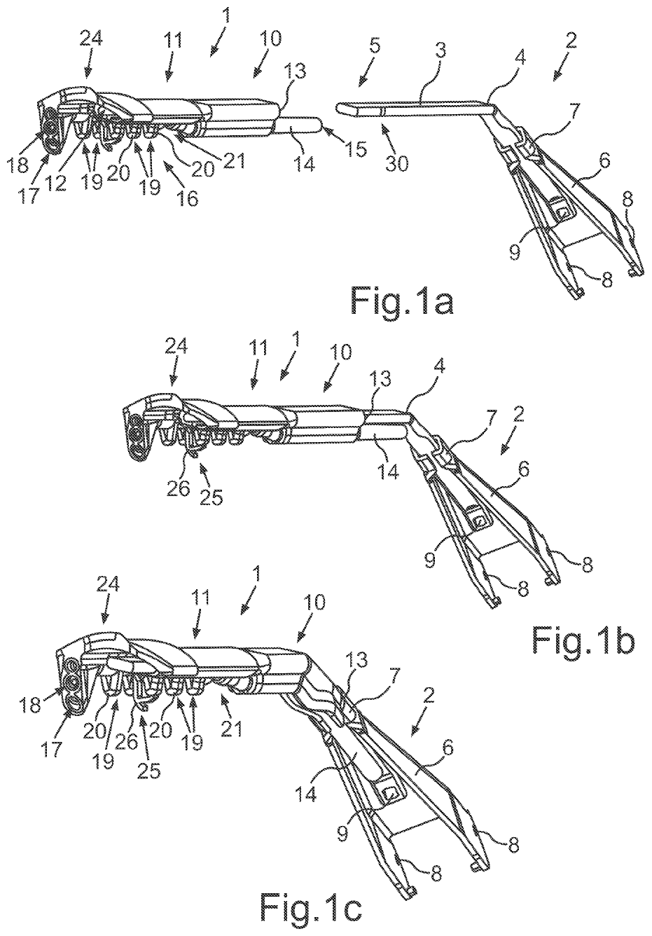

FIG. 1a-1c respective perspective representations of a mounting sequence of a functional element, which is formed as a wind deflector and includes a windscreen cleaning device, on a wiper rod of a wiper arm of a windscreen wiper system for a motor vehicle according to a first embodiment, wherein FIG. 1a shows the functional element still separate from the wiper rod, FIG. 1b shows the functional element in partially fitted position on the wiper rod, and FIG. 1c illustrates the functional element completely fitted onto the wiper rod;

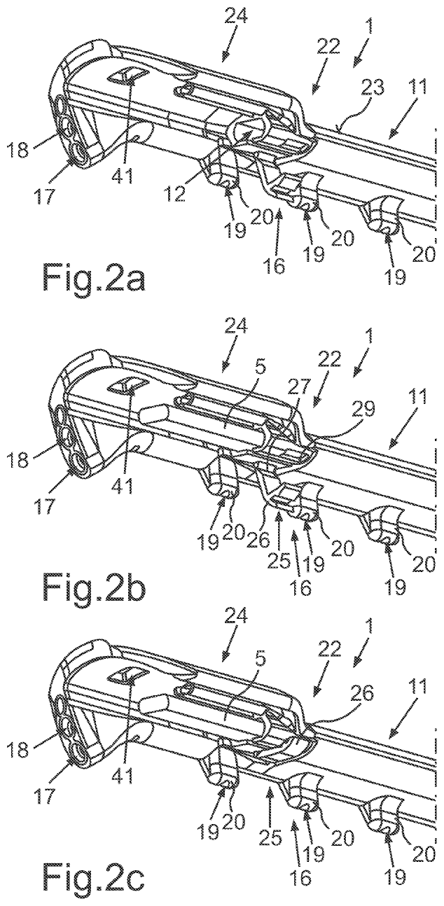

FIG. 2a-2c respective partial perspective representations of the functional element of the first embodiment of the windscreen wiper system, wherein FIG. 2a shows the functional element before fitting onto the wiper rod, FIG. 2b shows the functional element in completely fitted position, but not yet secured by means of an attachment device, and FIG. 2c illustrates the functional element subsequently fixed to the wiper rod by means of the attachment device;

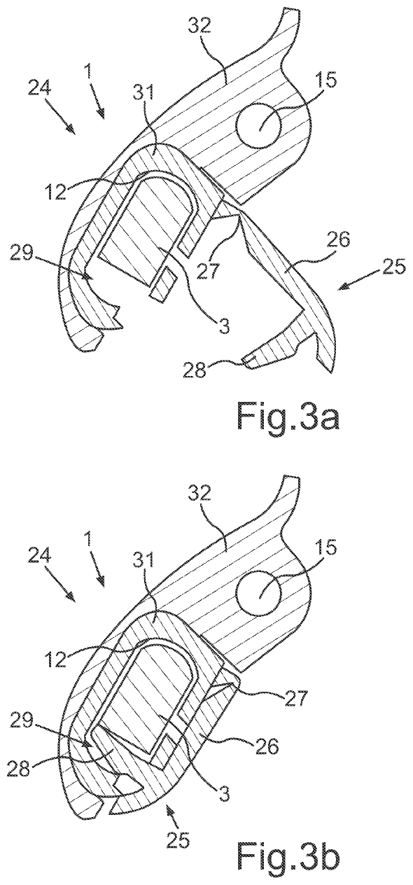

FIG. 3a, 3b respective sectional views through the functional element in its position arranged on the wiper rod, wherein in FIG. 3a the attachment device for fixing the functional element to the wiper rod is illustrated in opened state and in FIG. 3b the attachment device is illustrated in closed position fixing the functional element to the wiper rod;

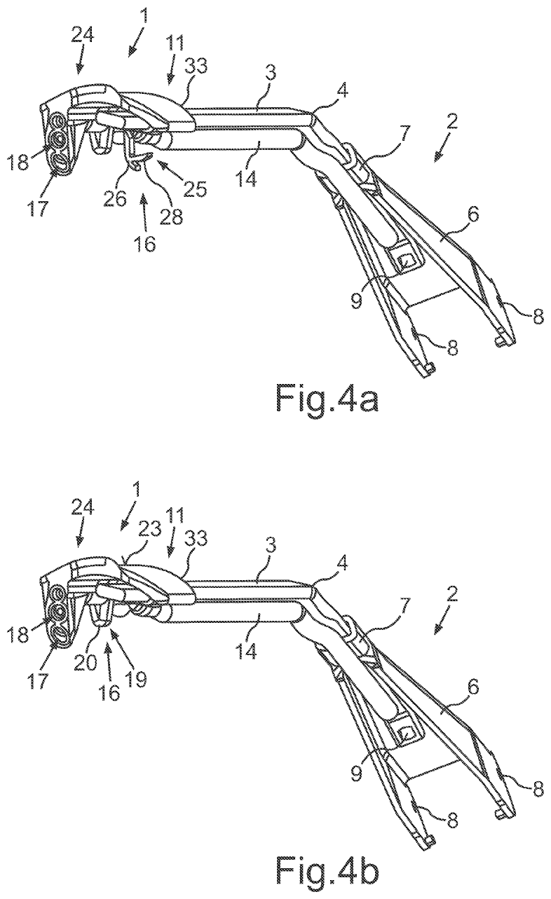

FIG. 4a, 4b respective perspective views to a functional element attached to the corresponding wiper rod according to a further embodiment, in which the functional element is formed shorter and accordingly does not extend up to the spring case of the wiper arm, wherein FIG. 4a shows the functional element with an opened attachment device and FIG. 4b with a closed attachment device;

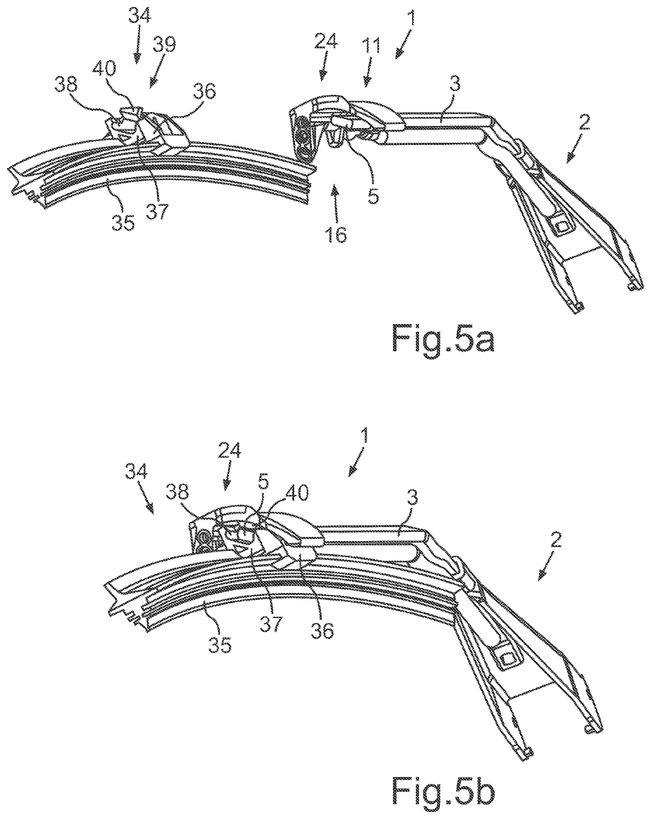

FIG. 5a, 5b respective perspective views of the wiper arm with the functional element mounted thereon according to FIGS. 4a and 4b, wherein FIG. 5a shows a wiper blade before its mounting and FIG. 5b shows the wiper blade after mounting by means of an adapter, which is arranged on and fixed to the free end of the wiper rod of the wiper arm independently of the functional element.

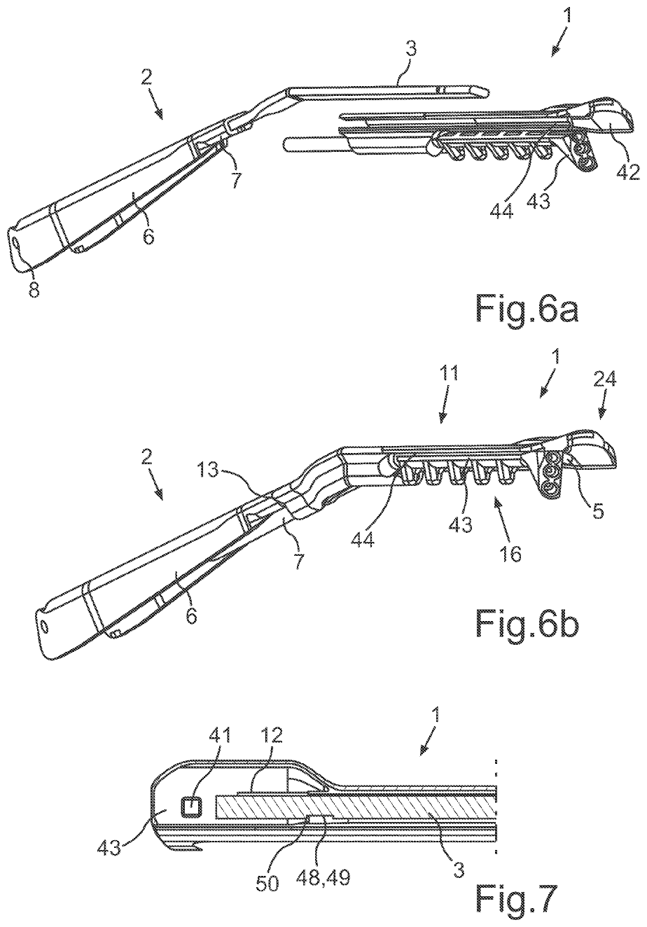

FIG. 6a, 6b respective perspective views to a functional element attached to the corresponding wiper rod according to a further embodiment, in which the functional element is formed of two parts, which are connected to each other at a film hinge or the like and can be connected to each other and attached to the wiper rod, respectively, by folding, wherein FIG. 6a shows the functional element before fixing to the wiper rod and FIG. 6b shows the functional element after fixing to the wiper rod;

FIG. 7 a partial sectional view through the functional element as well as the associated wiper rod, to which the functional element is attached, along a sectional plane, which extends in a separating plane between the two parts of the functional element, wherein in particular an attachment device becomes apparent, by means of which the functional element is secured to the wiper rod; and

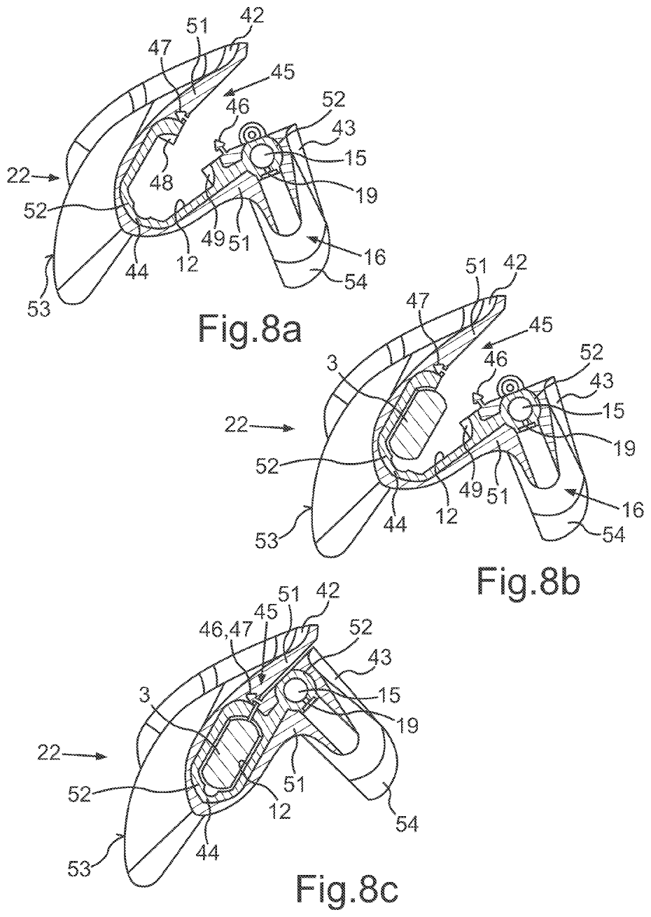

FIG. 8a-8c respective sectional views through the functional element according to FIGS. 6a to 7, wherein FIG. 8a shows the two parts of the functional element in opened state analogously to FIG. 6a, FIG. 8b shows the functional element with the two parts in position arranged on the wiper rod, but not yet closed, and FIG. 8c illustrates the two parts of the functional element after attachment to the wiper rod.

The embodiments explained in the following are preferred embodiments of the invention. In the embodiments, the described components of the embodiments each represent individual features of the invention to be considered independently of each other, which also each develop the invention independently of each other. Therefore, the disclosure also is to encompass combinations of the features of the embodiments other than the illustrated ones. Furthermore, the described embodiments can also be supplemented by further ones of the already described features of the invention.

In the figures, identical reference characters each denote functionally identical elements.

FIGS. 1a, 1b and 1c show a mounting sequence for arranging and fixing a functional element 1, explained in more detail below, to a wiper arm 2 in a respective perspective view. Herein, the wiper arm 2 and the functional element 1 are first illustrated separated in exploded manner in FIG. 1a.

Herein, it is in particular apparent that the wiper arm 2 includes a wiper rod 3, which is angularly formed in a bend area 4. The wiper rod 3 is fixedly connected to a spring case 6 on a side opposite to a free end 5, which is at least substantially rectangularly formed in cross-section in a connection area 7 and crimped onto the wiper rod 3 also at least substantially rectangular in cross-section. The spring case 6 is connected to a lever element, not illustrated, of the windscreen wiper system in articulated manner via bearing openings 8, which is occasionally also referred to as attachment part, which in turn is rotationally fixedly connected to an associated drive shaft of a drive motor. The wiper arm 2 is pivotable around the axis formed by the bearing pins 8 with respect to the associated lever element against the spring force of a spring element, which in turn can be hooked in a spring receptacle 9 at the corresponding end of the wiper rod 3, for example to press the wiper arm 2 and an associated wiper blade, respectively, against the surface of a front windscreen in the operating position.

The functional element 1 comprises a first partial area 10 and a second partial area 11 formed integrally with it, within which a continuous receiving channel 12 for the wiper rod 3 is provided. Therein, the receiving channel 12 is at least substantially adapted in cross-section to the approximately rectangular cross-section of the wiper rod 3, which has an at least substantially uniform cross-section over its entire extension. Accordingly, the receiving channel 12 also has a substantially uniform cross-section over its entire length within the functional element 1.

As is further apparent in synopsis with the FIGS. 1b and 1c, the functional element 1 can accordingly be fitted or shifted onto the wiper rod 3 from the free end 5 until an end 13 of the first partial area 10 of the functional element 1 joins to the connection area 7 of the spring case 6 in at least substantially flush manner. In order that fitting of the functional element 1 onto the wiper rod 3 up to the spring case 6 can be effected, the functional element 1 is manufactured of an elastic material, for example a corresponding plastic, in the first partial area 10—starting from the end 13—at least over the bend area 4. By this soft-elastic material, it is optionally also conceivable that the connection area 7 of the spring case 6 is surmounted by the end 13 of the partial area 10 of the functional element 1 in sleeve-like manner.

In addition, the end 13 of the partial area 10 is surmounted by a conduit part 14, via which the functional element 1 can be supplied with a windscreen cleaning liquid in a manner described in more detail below. Accordingly, at least one supply channel 15 for windscreen cleaning liquid is formed within the conduit part 14, via which the functional element 1 can be supplied with windscreen cleaning liquid in a manner described in more detail below. This supply channel 15 further extends also over the partial area 10 as well as over the partial area 11 of the functional element 1. Accordingly, a windscreen cleaning device 16 or a part of it is formed in the functional element 1 such that the wiper arm 2 is a so-called wet wiper arm in the present case. This means that the windscreen to be cleaned by means of the windscreen wiper system, in particular the front windscreen of the motor vehicle, can be supplied with windscreen cleaning liquid via nozzles, which are carried by the wiper arm 2. Therein, the end of the conduit part 14 of the functional element 1 is connected to the windscreen cleaning system for windscreen cleaning liquid along with associated pump via a channel arrangement not further shown. Usually, it is accommodated in the front space or engine compartment of the motor vehicle. As is in particular apparent from FIG. 1c, the conduit part 14 extends on the bottom side of the wiper rod 3 further up to the interior of the spring case 6 in the present case.

In synopsis of the FIGS. 1a to 1c, it is furthermore apparent that shifting the functional element 1 onto the wiper rod 3 is effected until it—as is apparent from FIG. 1c in the finally mounted position of the functional element 1—protrudes from the receiving channel 12 over a substantial length area at a free end 5. Inversely, this means that the functional element 1 with the partial areas 10, 11 is connected to a length area of the wiper rod 3 spaced from the free end 5 of the wiper rod 3 via the receiving channel 12.

In other words, the free end 5 protrudes beyond the partial area 11 of the functional element 1 and from the receiving channel 12, respectively.

The windscreen cleaning device 16 integrated in the functional element 1 presently includes a channel system with respective channels integrated in the functional element 1, which open into diverse nozzles, via which the windscreen to be cleaned and to be wiped, respectively, and the wiper blade explained in more detail below, respectively, can be supplied with windscreen cleaning liquid.

Thus, the windscreen cleaning device 16 first includes two outer circle nozzles 17, 18, via which the wiper blade is supplied in the near area of its outer circle, thus that area, in which the wiper blade traverses the largest radius of its surface to be wiped. Therein, the outer circle nozzle 17 covers an area closer to the functional element 1 and the outer circle nozzle 18 covers an area further away from the functional element 1 near the outer circle of the corresponding wiper blade.

In addition, the windscreen cleaning device 16 includes a plurality of presently five central nozzles 19, which all extend at least substantially in a row along the extension direction of the functional element 1. The respective nozzles 19 are accommodated in respectively associated protrusions 20 protruding from the functional element 1 and from the wiper arm 2, respectively, towards the windscreen to be wiped and to be cleaned in a manner described below. Finally, the windscreen cleaning device 16 includes at least one inner circle nozzle 21, via which the wiper blade of the wiper arm 2 is supplied with cleaning liquid in the area of its inner circle, in which the wiper blade traverses its shortest radius of the corresponding wiping surface in the wiping operation. Therein, all of the nozzles 17, 18, 19 and 21 can be adjusted such that they apply the cleaning liquid to the windscreen, in particular the front windscreen, at a corresponding distance in front of the wiper blade moving thereto upon a start movement, thus upon an upwards movement of the respective wiper arm 2 in case of a front windscreen. Optionally, the wiper blade can also be immediately supplied with the windscreen cleaning liquid.

Besides the integration of the windscreen cleaning device 16, the functional element 1 includes the further function of wind deflection. Accordingly, the functional element 1 is formed as a wind deflector 22 in the present case and includes a wind deflecting contour 23 on the front and top side, respectively, at least substantially facing away from the nozzles 19 as well as the wiper rod 3 to accordingly allow a particularly beneficial overflow of the air usually flowing to the respective wiper arm 2 and the corresponding wiper blade, respectively, from the front.

Thus, the present functional element 1 is formed as a wind deflector 22 and for integration of the windscreen cleaning device 16. However, it is to be considered as encompassed within the scope of the invention that the functional element 1 could also perform only one of these two functions.

The FIGS. 2a to 2c show the functional element 1 of the embodiment described in the FIGS. 1a to 1c in respective partial and perspective bottom views. Therein, the receiving channel for the wiper rod 3 is in particular apparent from FIG. 2a, which from a third partial area 24 of the functional element 1, which is also formed integrally with the partial areas 10 and 11. Therein, the FIGS. 2b and 2c show the position of the functional element 1 when it is completely fitted onto the wiper rod 3. In this position, the third partial area 24 of the functional element 1 covers the free end 5 of the wiper rod 3, in particular at the front side thereof and on the bottom side thereof—related to the installation position of the wiper arm 2. Further, it is apparent that the wiper rod 3 is arranged recessed with respect to the partial area 24.

Based on a synopsis of the FIGS. 2a and 2b with that according to FIG. 2c, it is additionally apparent that the functional element 1 is arranged secured to the wiper rod 3 of the wiper arm 2 in extension direction of the receiving channel 12 by means of an attachment device 25 in the present case. In the present case, the securement is effected by means of a flap 26, which is pivotably arranged on the functional element 1 via a film hinge 27. If the flap 26 is inserted by means of a locking element 28 into a locking receptacle 29 provided hereto in the area of the receiving channel 12, thus, the locking element 28 also engages with a groove 30 (FIG. 1a) within the wiper rod 3. Hereby, an axial securement of the functional element 1 on the wiper rod virtually results such that the functional element 1 is correspondingly secured in position after shifting onto the wiper rod 3.

In the FIGS. 3a and 3b, the attachment device 25 is again explained in its functionality in a respective sectional view of the arrangement of the functional element 1 on the wiper rod 3. Herein, it is in particular apparent how the axial securement of the locking element 28 on the side of the flap 26 within the locking receptacle 29 or at the groove 30 of the wiper rod 3 results.

Based on the different hatchings, it additionally becomes clear from the FIGS. 3a and 3b that the functional element 1 is presently manufactured as a plastic part in a two-component method, for example a two-component injection molding method. Herein, it is in particular apparent that the receiving channel 12 is formed by a hard component 31 in the area of the attachment device 25. Similarly, the respective channels carrying the cleaning liquid in the second and third partial areas 11, 24 of the functional element 1 are formed of this hard component 31 at least in the area of the respective nozzles 17, 18, 19, 21. Therebetween, parts can also be formed by a soft component 32 of the plastic, which incidentally also form the first partial area 10 and the conduit part 14—as already explained. The wind deflector contour 23 of the functional element 1 is also formed by the soft component 32—as it is apparent from the FIGS. 3a and 3b. Therein, the components 31, 32 are in particular formed UV-resistant to be correspondingly permanently durable.

In the FIGS. 4a and 4b, an alternative embodiment of the functional element 1 is illustrated in a respective perspective view. This functional element 1 is substantially identical to that according to the first described embodiment in its configuration and function such that only the differences are to be addressed below. This functional element 1 substantially differs in that in it the first partial area 10 of the functional element 1, which extends between the second partial area 11 and the connection area 7 of the spring case 6, is not provided here. Rather, the functional element 1 terminates with an end 33 at a distance before the bend area 4 and accordingly at a substantial distance before the connection area 7 of the spring case 6. The conduit part 14 of the functional element 1 accordingly extends over a substantial length without additional sheathing of the wiper rod 3 below or inside it up into the spring case 6, from where the further connection for supply with the cleaning liquid is effected.

Depending on how shortly the functional element 1 is formed, one or multiple respective inner circle nozzles 21 can optionally be omitted in some embodiments. Such a configuration for example arises in vehicles of the compact class, in which a relatively low windscreen surface has to be wiped and cleaned, respectively. On a respective passenger's side of a larger windscreen too, such a concept optionally also offers itself. Incidentally, the windscreen cleaning device 16 integrated in the functional element 1 has a configuration at least substantially identical to the embodiment already described in context of the FIGS. 1a to 3b. However—according to length of the functional element 1 and in particular of the partial areas 11 and 24, respectively—a lower number of central nozzles 19 can be provided. In the present embodiment too, the locking element 28 is again apparent, by means of which the functional element 1 can be secured after fitting onto the wiper rod 3.

In the FIGS. 5a and 5b, mounting of a wiper blade 34 on the corresponding free end 5 of the wiper rod 3, which protrudes from the receiving channel 12 of the functional element 1, is finally illustrated in a respective perspective view. Therein, the wiper blade 34 includes a wiper blade element 35, to which a basic body in the form of a slider 36 is attached. This slider 36 is in turn connected to an adapter 37 in articulated manner such that the wiper blade element 35 with the slider 36 can be pivoted relatively to the adapter 37 to a certain extent. The adapter 37 includes a receptacle 38 formed at least partially open in the present case, via which the adapter 37 and thus the entire wiper blade 34, respectively, can be fitted at the free end 5 of the wiper rod 3. Hereto, the receptacle 38, which is formed as a type of plug-in receptacle, is adapted in its cross-section and in its shape, respectively, to the cross-section of the wiper rod 3. After the adapter 37 with the receptacle 38 is fitted onto the free end 5 of the wiper rod 3 over a certain length area, a locking device 39 engages, which includes a corresponding locking element both on the side of the adapter 37 and on the side of the wiper rod 3. This locking device 39 can for example include a locking pin or the like on the side of the adapter 37, which engages with a locking recess on the side of the free end 5 of the wiper rod 3. Therein, the locking device 39 is detachable by means of an actuating element 40 in the form of a push button or the like, which has to be pressed towards the wiper blade element 39 in the present case.

In its locked position, this actuating element 40 penetrates a passage opening 42 within the partial area 24 of the functional element 1. In the locked position of the locking device 39, thus, the actuating element 40 is at least substantially arranged within this passage opening 41 and accordingly can be actuated from the front outside to remove the wiper blade 34 from the free end 5 of the wiper rod 3.

Since the functional element 1 thus is attached to the wiper rod 3 in a length area of it spaced from the free end 5 and the adapter 37 of the wiper blade 34 is attached to the free end 5 of the wiper rod, a completely independent respective arrangement and fixing to the wiper rod 3 results for the functional element 1 and the wiper blade 34. This has the advantage that the wiper blade 34 can be removed and for example exchanged from time to time completely independently of the functional element 1 without this having an influence on the functionality of the functional element 1. Therein, it is in particular to be taken into account that both the wind deflecting function and the windscreen cleaning function of the functional element 1 is completely maintained even if the adapter 37 is removed, but the functional element 1 remains on the wiper rod 3. In contrast to other systems, thus, a part of the wind deflecting device or the windscreen cleaning device is not removed and for example disposed of with the exchange of the wiper blade 34, which creates corresponding financial problems and problems arising with respect to the sustainability. Rather, a system is thus provided, in which the connection of the wiper blade 34 and the connection of the functional element 1 as well as performing the functions accomplished by the functional element are completely autonomous from each other.

Moreover, further elements can be integrated in the functional element 1. In particular, a heating for the windscreen cleaning device can also be integrated. Here too, the advantages already described in context of the windscreen cleaning device arise.

In the FIGS. 6a and 6b, a further, alternative embodiment of the functional element 1 is illustrated in a respective perspective view. This functional element 1 too is substantially identical to that according to the first described embodiment in its configuration and function such that only differences are to be addressed below. This functional element 1 substantially differs in that it is composed of two parts 42, 43, which are integrally connected to each other in the manner of a film hinge. Here, a completely two-part variant would optionally also be conceivable.

In synopsis with the FIGS. 8a to 8c, which show a respective cross-sectional view through the functional element 1 and the wiper rod 3, respectively, therein, it becomes apparent in which manner the arrangement and fixing of the two parts 42, 43 and of the functional element 1 overall, respectively, to the wiper rod 3 are effected. According to the FIGS. 6a and 8a, respectively, therein, the functional element 1 is shifted and/or fitted onto the wiper rod 3 with opened parts 42, 43 until the wiper rod 3—as it is in particular apparent from FIG. 8b—is arranged in its intended receiving channel 12, which is formed analogously to the receiving channels 12 according to the first two embodiments. Subsequently thereto, the two parts 42, 43 can then be pivoted against each other around the axis formed by the film hinge 44 or the like until the parts 42, 43 are connected to each other by means of the attachment device 45 on the side facing away from the film hinge 44 in the present case. Herein, the attachment device 45 includes one or more locking elements 46 at the one part 43, which—as it is in particular apparent from FIG. 8c—engage with each one or more corresponding locking receptacles 47.

In addition, a respective securing lug 48, 49 is arranged at both parts 42, 43, which—as it is apparent from FIG. 7—engage with a groove 50 in the wiper rod 3. The securing lugs 48, 49 thus act as an axial securement of the attachment device 45 in their cooperation with the groove 50 to avoid displacement of the functional element 1 in extension direction of the wiper rod 3.

The divided design of this functional element 1 with the parts 42 and 43 thus offers the advantage that the functional element 1 can be fixed to the wiper rod 3 in simple manner even if the wiper rod 3 for example has a non-rectilinear extension or a bend area 4. Therein, the functional element 1 can extend both up to the spring case 6 and to the connection area 7 thereof, respectively, and terminate at a distance to this connection area 7.

In particular, it is additionally apparent from the FIGS. 8a to 8c that—as in the preceding embodiments—the functional element 1 is formed partially of an elastic plastic component 51 and partially of a hard plastic component 52. In the present case, the receptacle or the receiving channel 12 is formed of the hard plastic component 52 at least in the partial area 11, but for example also in the partial area 10, in the present case, to thus obtain a particularly fixed and secure arrangement of the functional element 1 on the wiper rod 3.

In addition, in the present case, all of the liquid-carrying components of the windscreen cleaning device 16, thus for example the supply channel 15 as well as the respective nozzles 17, 18, 19, 21, are again at least substantially formed of the hard plastic component 52. The components of the windscreen cleaning device 16 carrying the cleaning liquid are thus particularly dimensionally stably and tightly designed.

However, the windscreen cleaning device 16 is therein—as it is in particular apparent from the FIGS. 8a to 8c—at least substantially completely integrated in the elastic plastic component 51.

In particular—related to the installation position of the functional element 1 or of the wind deflector 22—a surface 53 on its visible side is at least substantially completely formed by the elastic plastic component 51. Hereby, an optically particularly beneficial impression and moreover a functional element 1 arise, which is particularly well protected from strokes, impacts or the like. Therein, the elastic plastic component 51 is preferably formed of a UV-resistant material to be correspondingly persistent. In addition, the elastic plastic component 51 comprises protrusions 54, which for example serve as dampers to protect the functional element 1 or the wind deflector 22 as well as the surface of the windscreen to be cleaned.

In the two-component injection molding method for manufacturing the functional element or the wind deflector, a core for forming the supply channel 15 is first provided in the corresponding tool, which is overmolded by the hard plastic component 52. However, since the core has a relatively low cross-section of for example 2 to 3 mm as a result of the thin configuration of the supply channel 15 and is relatively long in contrast thereto, there is principally the risk that the core floats or is displaced as a result of the injection pressure in introducing the hard plastic component 52 into the tool. For this reason, the core is retained in place in one or multiple central areas of the supply channel 15 by means of sliders to avoid the described problem. However, the supply channel 15 is first interrupted hereby. In subsequently overmolding the hard plastic component 52 by the soft and elastic plastic component 51, these gaps are filled by the elastic plastic component 51. This is uncritical in a central area of the supply channel 15. In contrast, the essential locations such as couplings, outlet area of the nozzles 17, 18, 19 and 21, in which it depends on a sharp-edged contour, are formed of the hard plastic component 52.

Thus, it is overall apparent that a functional element 1 or a wind deflector 22 is presently provided, which can be particularly beneficially attached to the component of the wiper arm 2 in particular formed as a wiper rod 3 by the at least partial configuration of an elastic plastic component on the one hand, and which for example has beneficial aerodynamic characteristics on the other hand and moreover does not cause damages or annoying noises upon contact with the windscreen to be wiped.

1-10. (canceled)

11. A wind deflector assembly for a windscreen wiper system of a motor vehicle, comprising:
a wind deflector formed with a receptacle for attaching said wind deflector to a component of a wiper arm of the windscreen wiper system;
said wind deflector being at least partially formed of an elastic plastic component.

12. The wind deflector assembly according to claim 11, wherein said wind deflector is at least partially formed of a hard plastic component.

13. The wind deflector assembly according to claim 11, further comprising a windscreen cleaning device integrated in said wind deflector.

14. The wind deflector assembly according to claim 11, wherein a surface of said wind deflector, in an installation position of said wind deflector, is at least substantially completely formed by said elastic plastic component, at least on a visible side thereof.

15. The wind deflector assembly according to claim 13, wherein said windscreen cleaning device includes liquid-carrying components, and at least substantially all of said liquid-carrying components of said windscreen cleaning device are formed of said hard plastic component.

16. The wind deflector assembly according to claim 15, wherein said windscreen cleaning device is substantially completely integrated in said elastic plastic component.

17. The wind deflector assembly according to claim 15, wherein said windscreen cleaning device is completely integrated in said elastic plastic component.

18. The wind deflector assembly according to claim 11, wherein said receptacle for attaching said wind deflector to the component of the wiper arm of the windscreen wiper system is formed of a hard plastic component, at least in certain areas thereof.

19. The wind deflector assembly according to claim 11, wherein said receptacle is formed for attaching said wind deflector to a wiper rod of the wiper arm of the windscreen wiper system.

20. The wind deflector assembly according to claim 12, further comprising an attachment device for securing said wind deflector to a component of the wiper arm of the windscreen wiper system, which is formed of said hard plastic component.

21. The wind deflector assembly according to claim 11, wherein said elastic plastic component is formed of a UV-resistant material.
